(19) United States
(12) Patent Application Publication
(10) Pub. No.: US 2012/0042739 A1
(43) Pub. Date: Feb. 23, 2012

(54) SYSTEMS FOR TRANSMITTING DRIVE FORCE

(76) Inventor: Dashiell B. Parsons, Portland, ME (US)

(21) Appl. No.: 13/217,850

(22) Filed: Aug. 25, 2011

Related U.S. Application Data
(63) Continuation of application No. PCT/US2010/027366, filed on Mar. 15, 2010.
(60) Provisional application No. 61/159,919, filed on Mar. 13, 2009.

(51) Int. Cl. F16H 21/18

(52) U.S. Cl. 74/47

(57) ABSTRACT

The disclosure provides new crankshaft configurations for various purposes. In one embodiment, new crankshaft configurations are provided that are believed to be particularly suitable with internal combustion engines. Exemplary mechanisms convert a linear sinusoidal motion to a rotational one. In another embodiment, new crankshaft configurations are provided that are believed to be particularly suitable with manually operated drive systems, such as on bicycles. Exemplary mechanisms convert elliptic or linear reciprocating motion into angular motion.

### CROSS-REFERENCE TO RELATED APPLICATIONS

This patent application is a continuation of and claims priority to International Application No. PCT/US2010/27366, filed Mar. 15, 2010, which in turn claims the benefit of priority to U.S. Provisional Patent Application Ser. No. 61/159,919, filed Mar. 13, 2009. Each of the aforementioned patent applications is incorporated by reference herein in its entirety.

### BACKGROUND

1. Field of the Disclosure

The present disclosure relates to novel systems for transmitting drive force. Particularly, the present disclosure provides new crankshaft configurations for various purposes. New crankshaft configurations are also provided that are believed to be particularly suitable with manually operated drive systems, such as on bicycles.

2. Description of Related Art

A conventional, commercially available internal combustion engine utilizes a crankshaft to transform a reciprocating piston motion into a rotary motion. As the piston moves within its cylinder in response to expanding gases of combustion, rotary motion is imparted to the crankshaft through a connecting rod. One end of the connecting rod is affixed to a wrist pin pivotally secured to the piston, while another end is rotatably journaled about an offset throw of the crankshaft. When multiple cylinder arrangements are desired, the crankshaft is extended to include an additional offset throw for each piston connecting rod.

As the piston transmits force created by the combustion of fuel to the crankshaft by way of the connecting rod, the angularity of the connecting rod causes a considerable side thrust to be exerted by the piston on the walls of the cylinder. Such thrust is generally absorbed by a skirt portion of the piston; that is, the section below the piston rings. Further, this side thrust or angular force absorbs a portion of the linear energy and contributes to the inefficiency of the conversion of the linear movement of the piston into the rotary movement of the crankshaft.

In a conventional internal combustion engine, the crankshaft is supported by main bearings, and at the end of the crank throw, a crank pin holds the connecting rod. In order 4o to compensate for energy lost to angular forces, the piston rod is lengthened and the crank throw is made longer than the radius of the cylinder bore. Thus, additional space must be allowed to accommodate the crank throw. In addition, to avoid a downward thrust of the piston while the piston is at the upper limit of the stroke (top dead center), the crankshaft or crank pin may be offset from the longitudinal center of the cylinder, or alternatively a timing mechanism may be employed to delay spark ignition in the combustion chamber. These factors further contribute to increased size of so commercially available internal combustion engines.

Such conventional methods and systems generally have been considered satisfactory for their intended purpose. Various attempts have been made in the art to improve internal combustion engines. Examples of such attempts can be found, for example, in U.S. Pat. No. 7,263,966, U.S. Pat. No. 7,201,133, U.S. Pat. No. 5,417,309, U.S. Pat. No. 5,351,566, U.S. Pat. No. 4,395,977, U.S. Pat. No. 4,270,395, U.S. Pat. No. 4,078,439, U.S. Pat. No. 2,628,602 and U.S. Pat. No. 2,513,514. Each of the aforementioned references is incorporated by reference herein in its entirety.

However, many of the foregoing attempts have resulted in very complex mechanisms with a significant number of moving parts, which is very undesirable. Applicant believes that there is a long felt need in the art for further improved systems that improve upon the existing art.

### SUMMARY OF THE DISCLOSURE

Advantages of the present disclosure will be set forth in and become apparent from the description that follows. Additional advantages of the disclosure will be realized and attained by the methods and systems particularly pointed out in the written description and claims hereof, as well as from the appended drawings.

To achieve these and other advantages and in accordance with the purpose of the disclosure, as embodied herein, the disclosure includes an exemplary device for converting linear motion into rotational motion. The device includes a housing defining at least one bore therein along a first direction, and a piston movably disposed in the bore of the housing. The piston defines a generally circular bore therethrough along a direction generally perpendicular to the first direction. The bore of the piston defines a first engagement surface having a first diameter. The device further includes a crankshaft defining an axis of rotation and generally elongate body. The body has an offset portion that is laterally displaced from the axis of rotation. The surface of the offset portion defines a second engagement surface thereon having a generally circular cross-section and a second diameter. In accordance with a particular embodiment, the second diameter is about one half of the first diameter and the second engagement surface is adapted to engage with the first engagement surface. The crankshaft is forced through an angular rotation when the piston is displaced along the bore, and the axis of rotation of the crankshaft does not move with respect to the housing.

In accordance with a further aspect, the device further includes at least one bearing interposed between (i) a generally circular track defined in the bore of the piston and (i) the surface of the crankshaft. The bearing maintains the engagement between the first and second engagement surfaces when the piston is displaced along the bore of the housing resulting in rotation of the crankshaft. In accordance with one embodiment, the bearing is generally crescent-shaped.

In accordance with a further embodiment, the first and second engagement surfaces can define interdigitating gear teeth thereon. Preferably, the piston bore and cross section of the offset portion of the crankshaft defining the second engagement surface are circular in shape.

In accordance with still a further aspect, the housing can further define a second bore therein, and the device can further includes a second piston movably disposed in the second bore of the housing. The second piston preferably defines a generally circular bore therethrough along a direction generally perpendicular to the first direction. The bore of the piston defines a third engagement surface having a first diameter that is adapted and configure to mate with a fourth engagement surface defined on a second offset portion of the crankshaft.

In accordance with yet a further aspect, the piston is adapted and configured to reciprocate along the bore of the housing when the crankshaft rotates. In accordance with one embodiment, the housing can further define at least one intake valve and one exhaust valve proximate one end or at each end of the bore. If desired, the device can be an internal combustion engine wherein fuel is introduced into the intake valve during operation and combusted to drive the crankshaft. By way of further example, the device can be a pump or compressor, wherein a fluid to be pressurized by the device is introduced into the intake valve during operation. Preferably, the motion of the piston in the bore of the housing is sinusoidal.

The disclosure also provides a device for converting elliptic or linear reciprocating motion into angular motion. The device includes a central shaft defining an axis of rotation and a first crank portion. The device further includes a second crank portion lying in substantially the same plane as the first crank portion and pivotally attached to the first crank portion at a pivot point. the second crank portion is adapted to freely pivot about the central shaft about the axis of rotation and the pivot point is separated by a distance l₂ from the axis of rotation. The first crank portion preferably includes a load receiving point displaced a distance l₁ from the first pivot point, and the second crank portion preferably extends substantially perpendicularly from the central shaft.

In accordance with a further aspect, the first crank portion preferably includes a first sprocket affixed thereto in axial alignment with the pivot point, and wherein the central crankshaft includes a second sprocket affixed thereto in axial alignment with the axis of rotation. If desired, the device can further include a chain loop encircling the first and second sprockets, wherein rotation of the first sprocket about the pivot point causes rotation of the second sprocket and the central shaft by way of the chain. Alternatively, the device can instead include first and second gears in lieu of sprockets and a chain as described above or a third idler gear interposed between the first and second gears, wherein rotation of the first gear about the pivot point causes rotation of the second gear and the central shaft by way of the third gear. Preferably, the first sprocket and second sprockets (or gears, rollers or pulleys, described below) are of substantially the same diameter.

In accordance with a further aspect of the disclosure, l₁ can be substantially equal to l₂, resulting in the load receiving point traversing a substantially linear path as the central shaft is angularly driven. If desired, l₁ can be less than l₂, resulting in the load receiving point traversing a substantially elliptical path as the central shaft is angularly driven.

In accordance with an alternative embodiment, the first crank portion can include a first roller affixed thereto in lieu of a sprocket in axial alignment with the pivot point, and wherein the central crankshaft includes a second roller affixed thereto in axial alignment with the axis of rotation. If desired, the device can further include a belt encircling the first and second rollers, wherein rotation of the first roller about the pivot point causes rotation of the second roller and the central shaft by way of the belt. Alternatively, the device can further include a third idler roller interposed between the first roller and second roller, wherein rotation of the first roller about the pivot point causes rotation of the second roller and the central shaft by way of the third roller.

If desired, the first crank portion can include a first pulley in lieu of a sprocket affixed thereto in axial alignment with the pivot point, and wherein the central crankshaft includes a second pulley affixed thereto in axial alignment with the axis of rotation. The device can further include a belt encircling the first and second pulleys, wherein rotation of the first pulley about the pivot point causes rotation of the second pulley and the central shaft by way of the belt. If desired, the belt and pulleys can have interdigitating teeth.

In accordance with a further embodiment, a machine is provided including a sprocket/gear/roller/pulley drive mechanism as described hereinabove. The machine can be, for example, a bicycle, a tricycle, a quadricycle, an exercise bicycle, an electric generator, a pedal taxi or a paddleboat.

It is to be understood that the foregoing general description and the following detailed description are exemplary and are intended to provide further explanation of the disclosed embodiments.

The accompanying drawings, which are incorporated in and constitute part of this specification, are included to illustrate and provide a further understanding of the method and system of the disclosed embodiments. Together with the description, the drawings serve to explain principles of the disclosed embodiments.

### BRIEF DESCRIPTION OF THE DRAWINGS

FIGS. 1-22 represent various views of a first exemplary illustrative embodiment of a device and system for transmitting drive force in accordance with the present disclosure, or portions thereof.

FIGS. 23-25 represent various schematic views of a second exemplary illustrative embodiment of a device and system for transmitting drive force in accordance with the present disclosure.

### DETAILED DESCRIPTION OF PREFERRED EMBODIMENTS

Reference will now be made in detail to the present preferred embodiments of the disclosure, examples of which are illustrated in the accompanying drawings. The method and corresponding steps of the disclosed embodiments will be described in conjunction with the detailed description of the system.

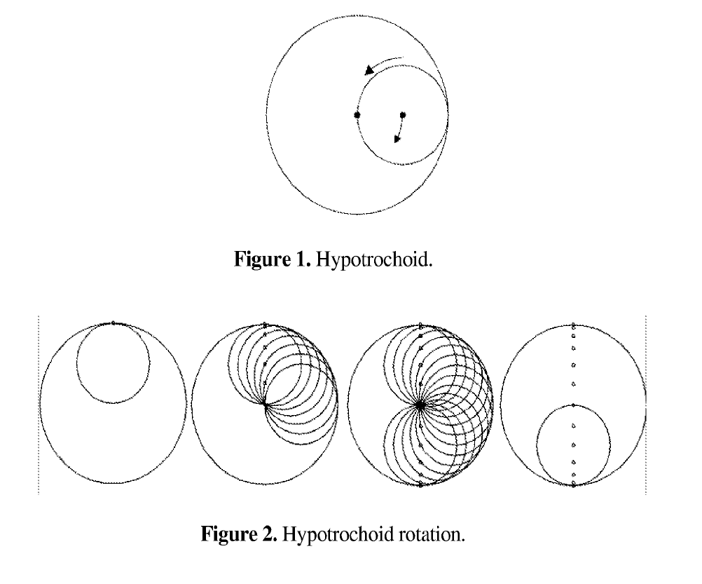

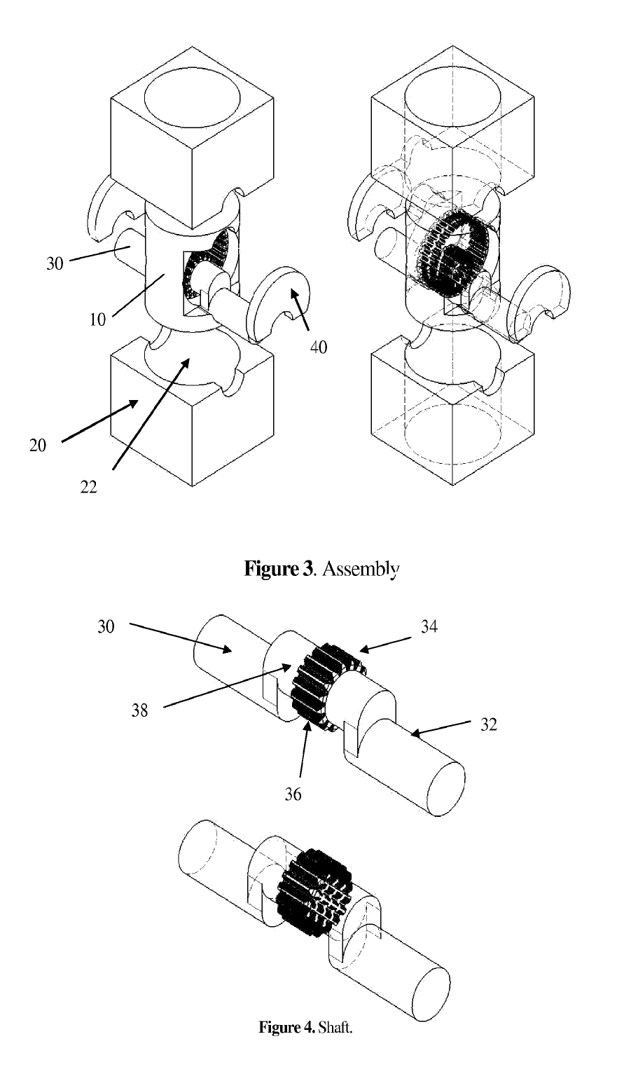

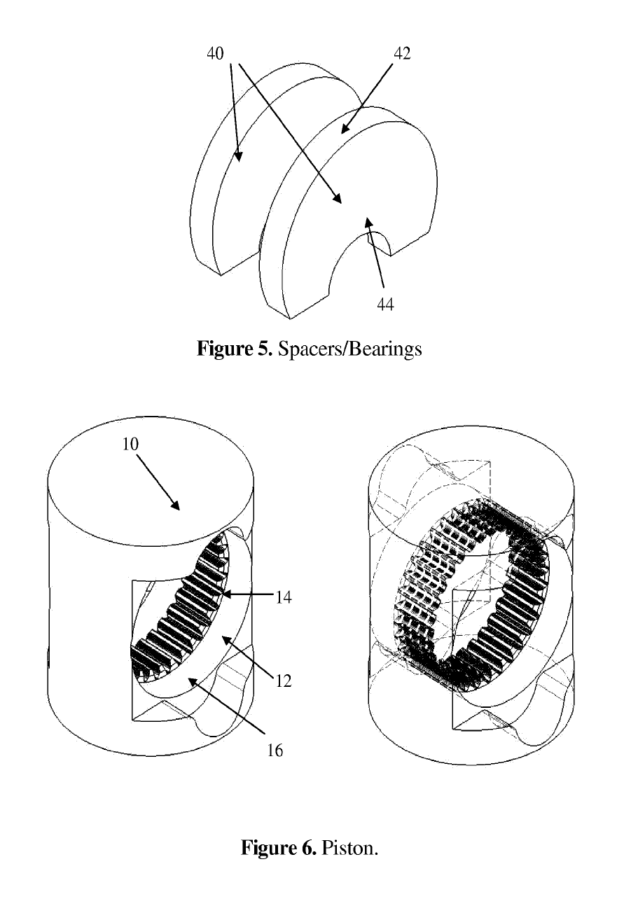

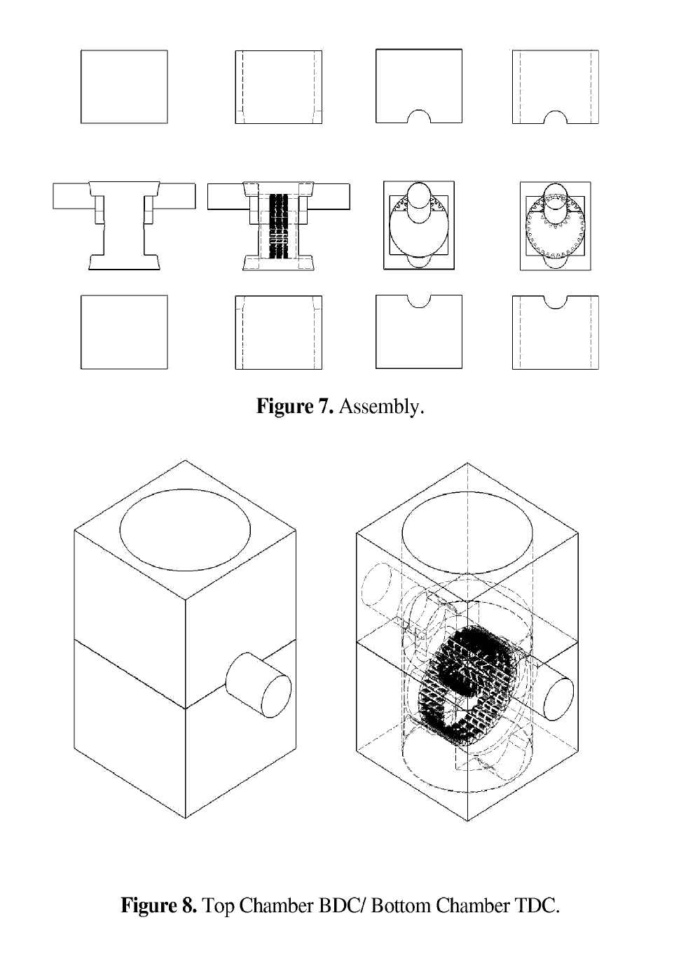

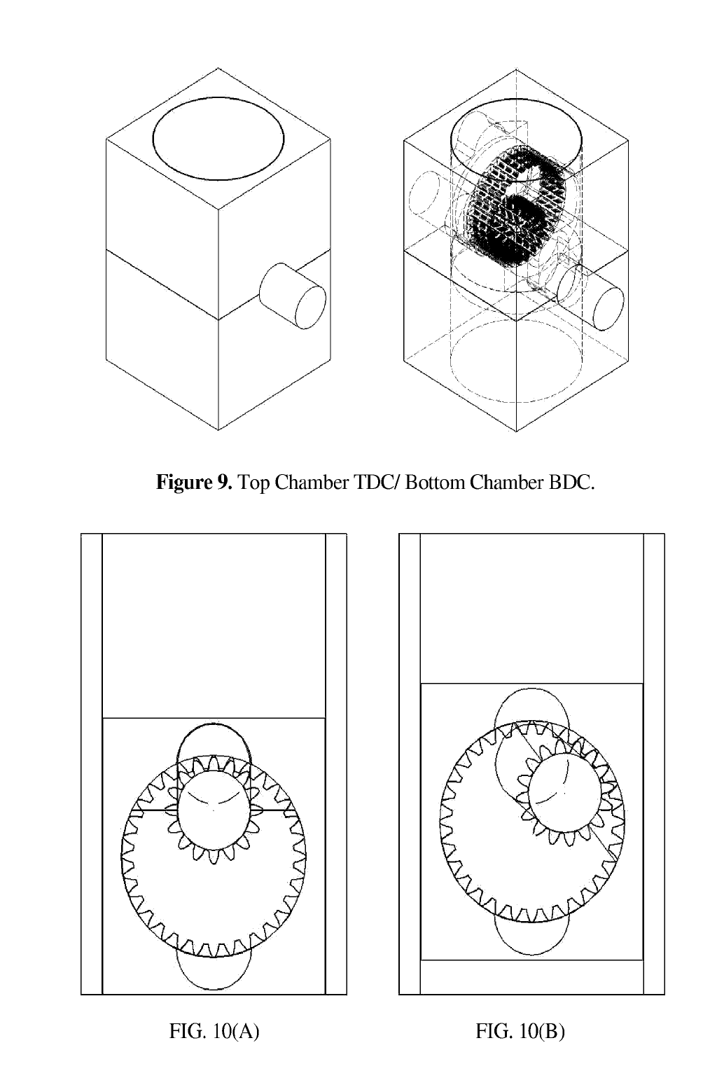

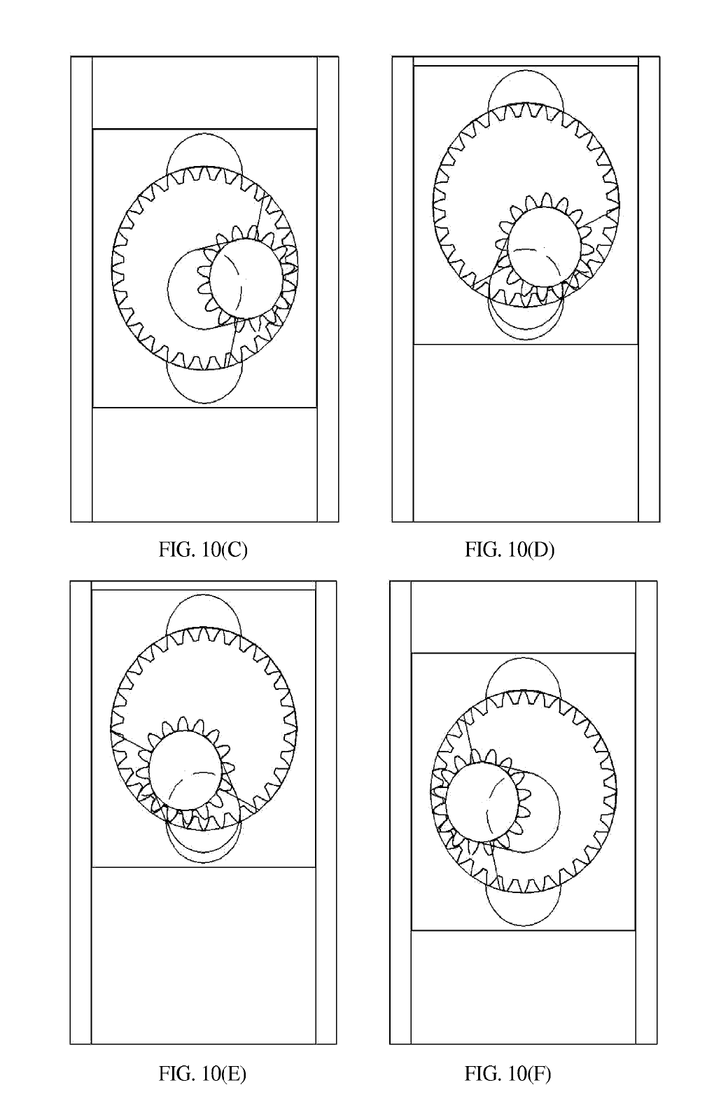

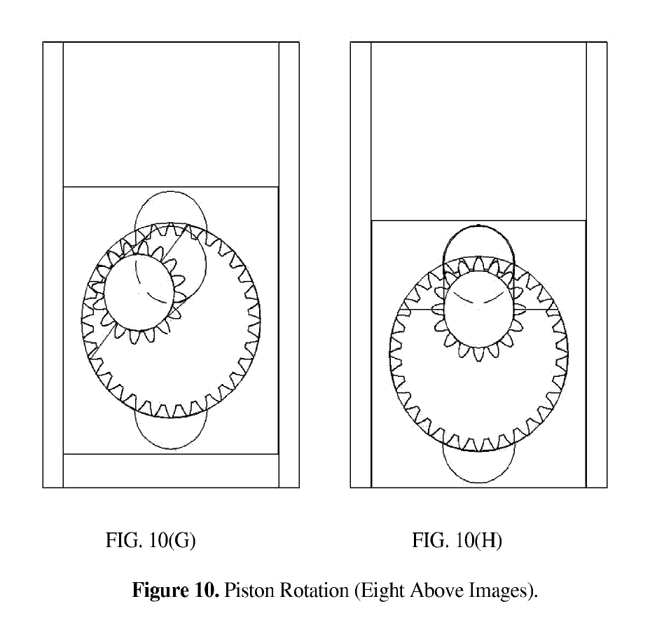

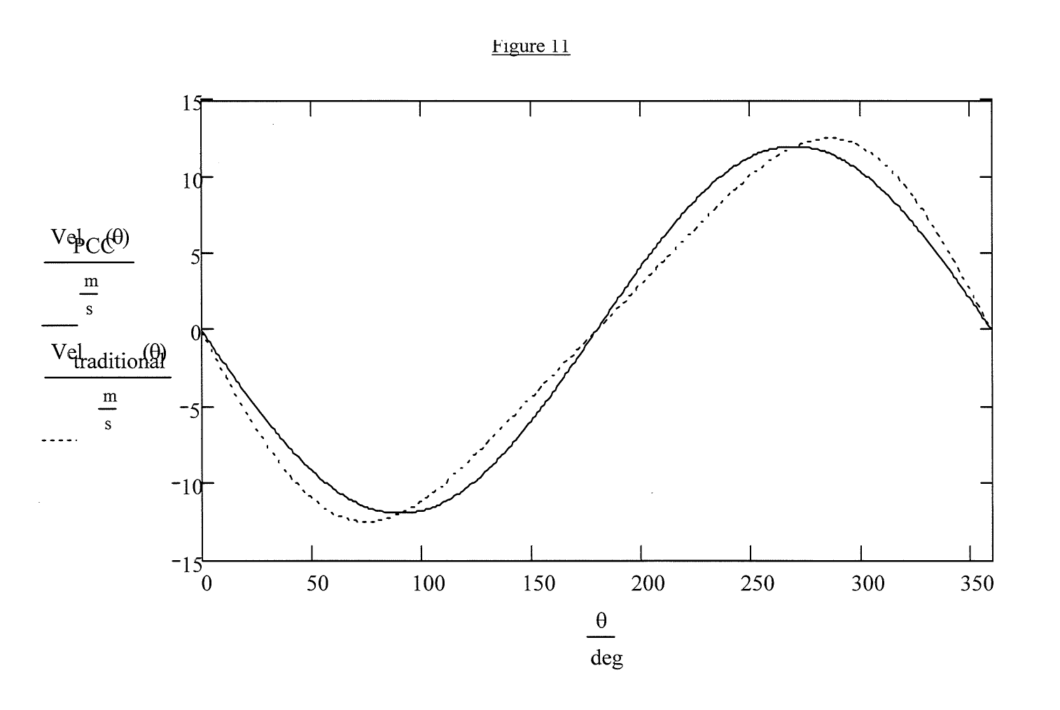

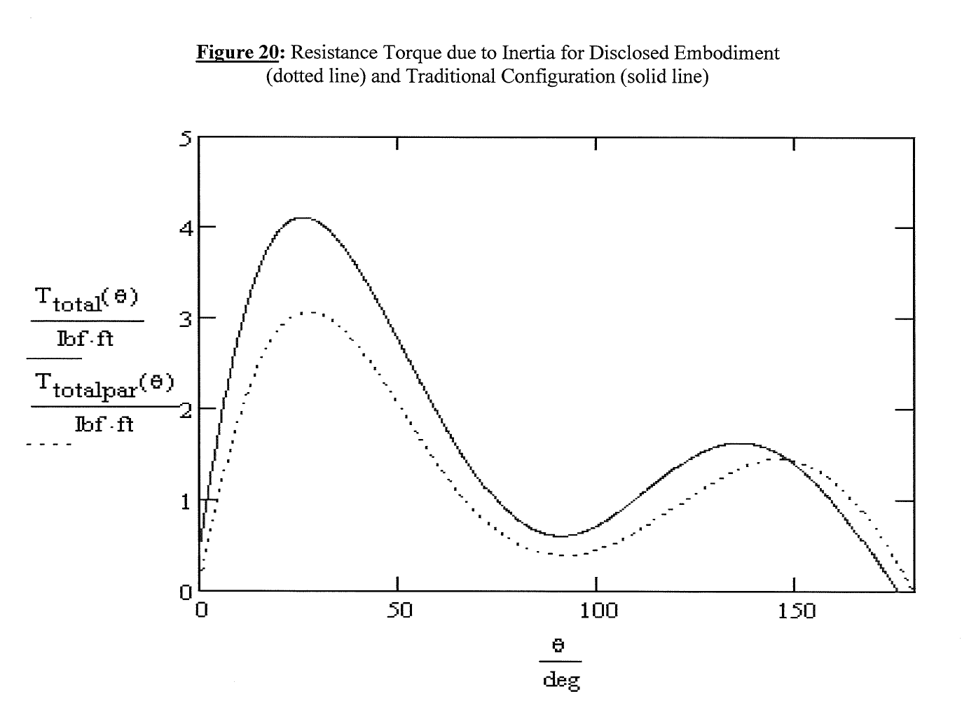

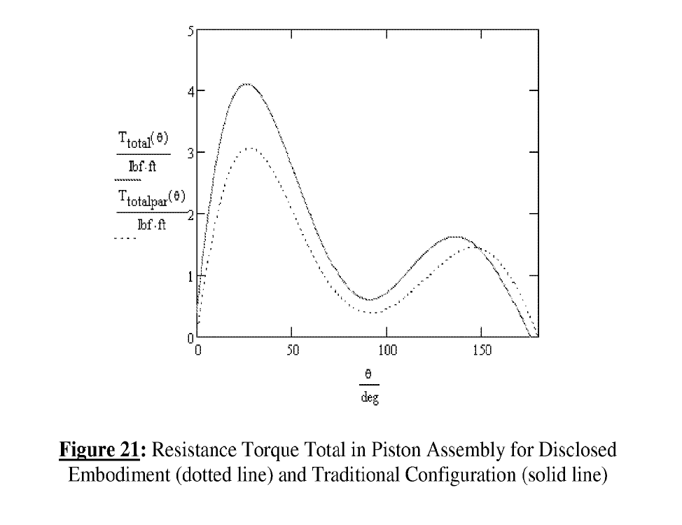

The modern piston internal combustion engine has undergone an evolution since its inception although, the basic components used to perform the motion of the slider crank model has remained the same. The piston, crank and connecting rod have always been apart of the piston engine. Exemplary disclosed embodiments will be discussed does not have the same elements found in the traditional piston engine. For example, there is no need for the connecting rod and piston to be separate parts due to the linear motion of the bearing which connects the piston to the crank, relative to the engine block. To achieve this, gearing is preferably employed between the crankshaft and the piston as illustrated in the exemplary embodiment of FIGS. 1-22.

The geometric relation that facilitates the operation of this embodiment may be defined in a hypotrochoid's geometry where the inner rotating circle is half the size of the larger stationary circle as depicted in FIG. 1. As the inner circle rotates about the outer circles center it is also forced to rotate about its own center at a ratio of 2 to 1. If any point on the smaller circle is then plotted through the rotation it may be seen that it will create a reciprocating sinusoidal motion as depicted in FIG. 2.

As illustrated in FIGS. 1 and 2, conceptually, the inner circle acts as the shaft and is constrained to one degree of freedom, allowed only to rotate only about the center of the system. The outer circle depicted in FIG. 2 is the piston and is constrained so that only a vertical translation is allowed. This is done simply by constraining the piston in the cylinder of the housing and by providing spacers, or bearings, that rotate around the crankshaft and within the piston. Specifically, as illustrated in the Figures, a two-headed piston 10 is depicted situated in the bore 22 of a housing 20. A crankshaft 30 is provided having a main portion 32 that rotates but that does not otherwise move with respect to the housing 20 and an offset portion 34 depicted with a plurality of gear teeth 36 thereon. Piston further defines a generally circular bore 12 therethrough depicted with a plurality of gear teeth 14 thereon that interdigitate and mesh with teeth 36 of crankshaft 30. A crescent-shaped bearing 40 is disposed on either side of the piston 10, wherein the radially outer surface 42 of bearing rides in a substantially circular track 16 of piston 10 and the radially inner surface 44 of bearing 44 rides on the surface 38 of crankshaft. Bearings 40 keep proper spacing between the gears. The gearing 14, 36 and spacers 40 are both responsible for transmitting torque to the crankshaft 30.

Vibration is a particular concern in traditional piston engine design due to the irregular oscillation of the piston in the slider crank mechanism. Many different engine configurations have been used in an effort to completely balance the piston engine but, because of the connecting rod masses change in relative position to the crankshaft axis there will be an inertia variation not found in the disclosed embodiment. (See References [1, 10] below). In the disclosed embodiment, the piston 10 does not operate according to a slider crank mechanism. Rather, the piston 10 moves in a vertical (for purposes of reference) sinusoidal motion. This allows for both forces and moments to be optimized using fewer cylinders. It will be appreciated that any desired number of pistons and cylinders can be used to make an engine or pump in accordance with the exemplary embodiment (e.g., 2, 3, 4, 5, 6, 7, 8, 9, 10, 11, 12 pistons/cylinders).

Some literature references have suggested that friction due to the piston ring assembly may be responsible for 40-75 percent of the entire engine friction (See References [2-5] below). Ring assembly friction is a function of the coefficient of friction and the normal load between the cylinder wall and ring assembly (See Reference [6] below). In a traditional piston engine there are three components to the normal load: (i) the static ring pressure, (ii) the inertia forces, and (iii) the pressure due to the combustion gasses. While the inertia forces in the exemplary embodiment do not go to zero, this force is considerably less than in the traditional piston engine.

The lack of a need for a connecting rod in the exemplary embodiment due to the entirely vertical component of force exerted to the crank pin means that two horizontally opposed pistons may be connected as one rigid part where each piston is offset 180 degrees. This enables the engine to be more compact using less space for the same piston displacement. It also has the ability to reduce the rotating and overall mass of the engine. Secondary motion of the piston in the horizontal direction or, piston slap is an entirely separate occurrence in the disclosed embodiment and can be expected to be significantly reduced without a horizontal force on the piston. Depending on a particular engine configuration, the illustrative embodiment also has the ability to reduce the total number of engine parts as compared with a traditional internal combustion engine.

A model has been developed by Applicant to measure and compare the torque distribution throughout the power stroke for both the traditional piston engine and the illustrated embodiment. Because of the linear sinusoidal motion in the illustrated embodiment, piston velocity just before and just after top dead center can be expected to be lower than in the traditional configuration. This creates a different torque distribution with more torque coming later in the power stroke, causing a smoother more desirable power output.

Piston position, velocity, acceleration and jerk can also be expected to change significantly by applying a linear sinusoidal motion to the piston position as with the disclosed illustrative embodiment. In the traditional slider crank mechanism of typical engines there is significantly higher peak acceleration when compared to that of the sine wave. Depending on the length of the connecting rod, peak acceleration may be reduced as much as 20 percent with respect to the disclosed embodiment (by way of comparison) while maximum jerk can be expected to be reduced by as much as 40 percent. This can be expected to reduce forces exerted on the piston, connecting rod and crankshaft as compared with a traditional engine design.

### Geometric Relations

In the disclosed embodiment, there is a common relation of motion between the piston and the crankshaft's center of rotation which is defined by the hypotrochoid's geometry (FIGS. 1-2). With reference to FIG. 11, equations 1 and 2 below govern point P as the smaller circle rolls around the circumference of the larger one. These equations are parametric in the variable t:

$$\begin{matrix}x = ( a - b ) \cdot cos ( t ) + c \cdot cos [ ( a - b ) \cdot \frac{t}{b} ] & ( 1 ) \\ y = ( a - b ) \cdot sin ( t ) + c \cdot sin [ ( a - b ) \cdot \frac{t}{b} ] & ( 2 )\end{matrix}$$

In the disclosed exemplary embodiment, the smaller circle of FIG. 11 is half the size of the larger and, c is equal to b. This puts the rotating point P at the edge of the smaller circle and causes it to move linearly between its two points of contact with the larger circle. If a line is drawn through these two contact points it will intersect the larger circle, passing through its center. If the time derivative is taken of the position, P as the small circle is rolling at a constant angular velocity around the circumference of the larger circle, the resultant velocity profile of point P will be sinusoidal.

### Piston Position, Velocity and Acceleration

Piston position for the traditional configuration and the exemplary embodiment are given in equations (3) and (4) respectively. The traditional configuration and assumes there is no piston offset.

$$\begin{matrix}{P}_{traditional} = - [ ( 1 + r ) - [ \sqrt{{1}^{2} - {( sin ( θ ) \cdot r )}^{2}} + cos ( θ ) \cdot r ] ] & ( 3 ) \\ {P}_{PCC} = r \cdot cos ( θ ) & ( 4 ) \\ {Vel}_{PCC} = \frac{d}{d θ} {P}_{PCC} ( θ ) \cdot ω \\ {Vel}_{traditional} = \frac{d}{d θ} {P}_{traditional} ( θ ) \cdot ω & ( 5 ) \\ {Acc}_{PCC} = \frac{d}{d θ} {Vel}_{PCC} ( θ ) \cdot ω \\ {Acc}_{traditional} = \frac{d}{d θ} {Vel}_{traditional} ( θ ) \cdot ω & ( 6 ) \\ {Jerk}_{PCC} = \frac{d}{d θ} {Acc}_{PCC} ( θ ) \cdot ω \\ {Jerk}_{traditional} = \frac{d}{d θ} {Acc}_{traditional} ( θ ) \cdot ω & ( 7 )\end{matrix}$$

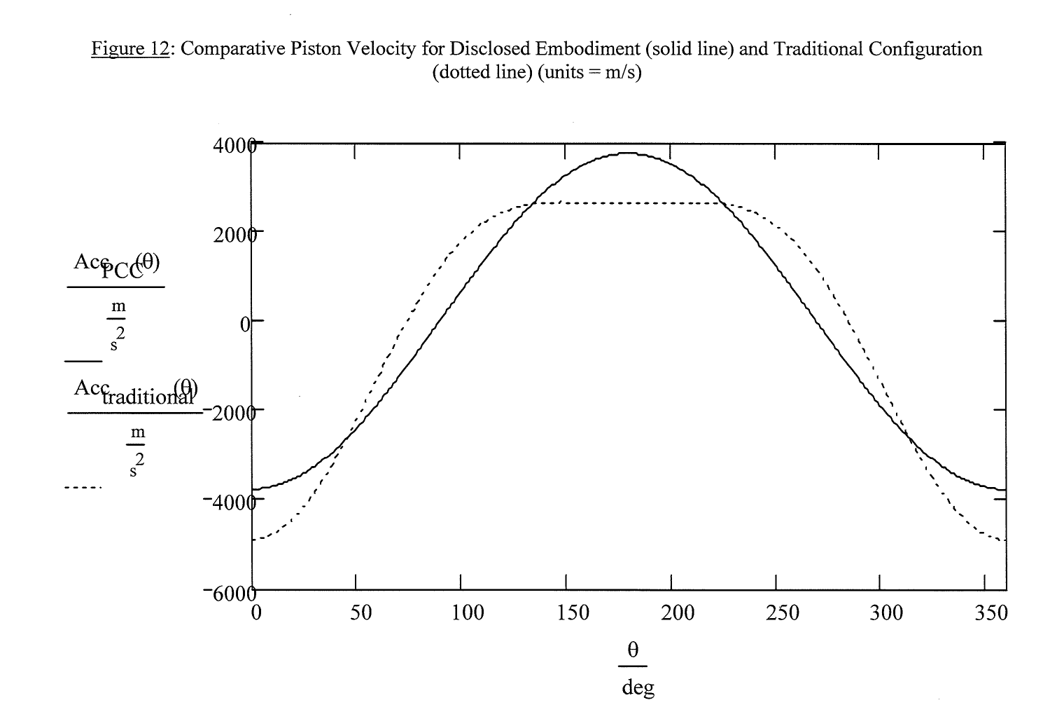

To obtain the piston velocity through one complete crankshaft rotation at 2000 revolutions per minute Equation (5) is used (see Reference [8] below). Results show that the exemplary embodiment has approximately a 6 percent smaller peak velocity than a traditional engine configuration with a 3 inch stroke and 5 inch connecting rod as illustrated in FIG. 12. As the length of the connecting rod goes to infinity, the profile of the traditional engine piston velocity becomes sinusoidal or matches that of the PCC. A larger peak velocity occurs as the connecting rod becomes smaller.

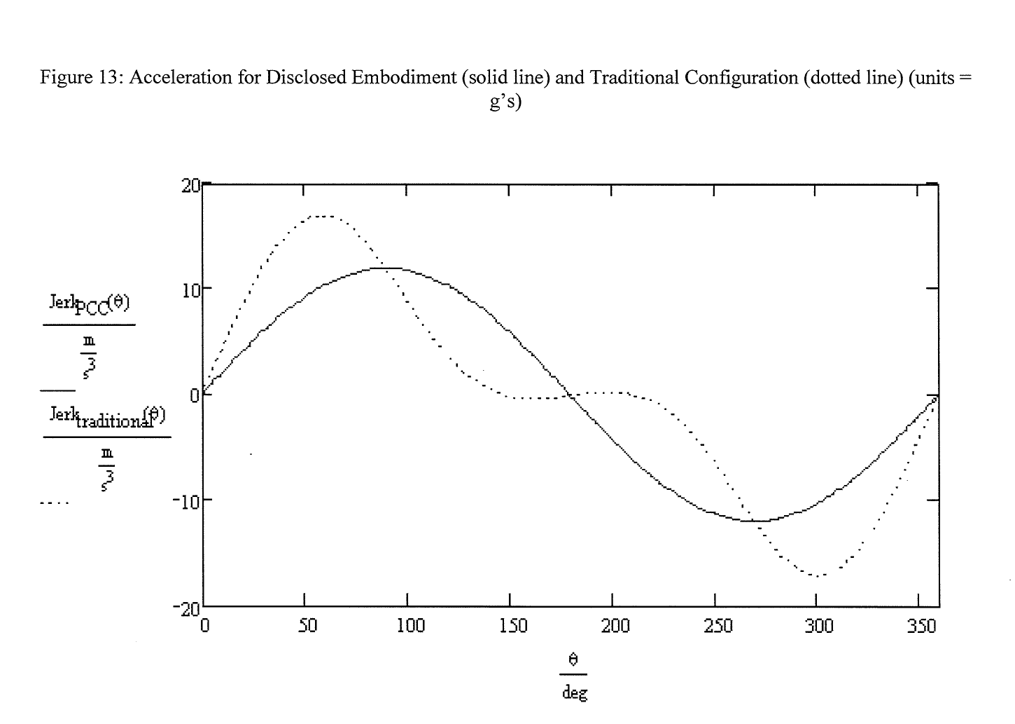

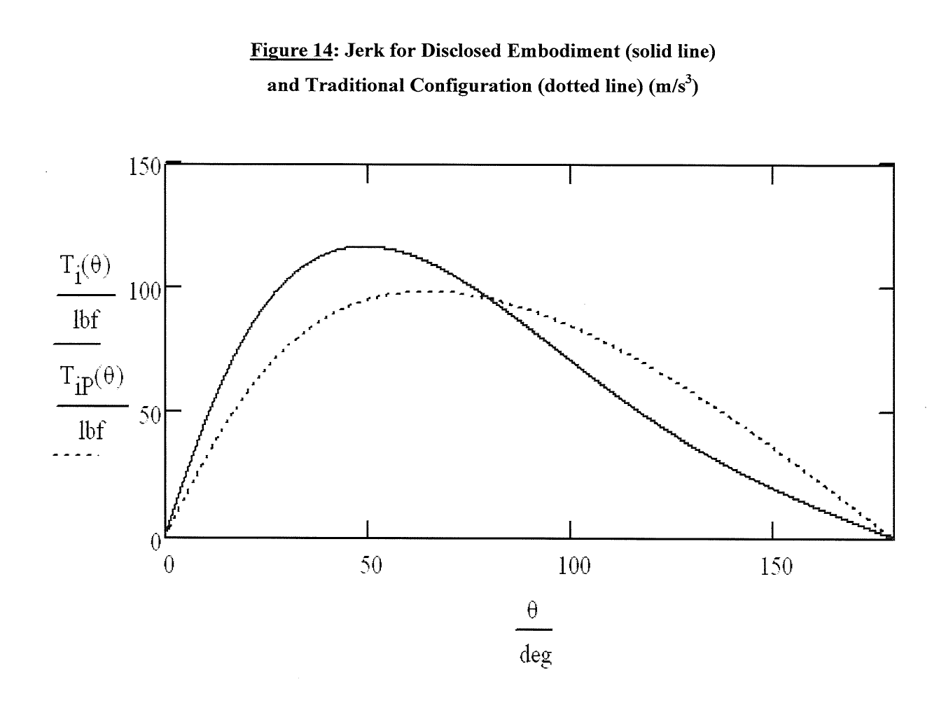

The second time derivative of position, multiplied by crank angular velocity squared may be calculated to obtain piston acceleration (Equation 6) (see Reference [8] below). The measure of acceleration is g's, or, the number of times the force of gravity the piston is experiencing. The peak acceleration is shown to be approximately 24 percent greater in the traditional piston engine as illustrated in FIG. 13. The change in rate of acceleration with respect of time or, jerk may be calculated using Equation (7) and is graphed in FIG. 14. As is apparent, the traditional slider crank mechanism generates approximately 44 percent more jerk then the sinusoidal piston displacement.

### Torque Distribution

Before the instantaneous friction components may be measured the torque distribution must be defined throughout the power stroke. To do this an isentropic process is assumed for an ideal gas. This introduces an error to the model due to temperature change, blow by and the flame rate. However, the pressure distribution created throughout the power stroke closely resembles the one produced and measured in Reference [6]. An initial pressure is prescribed of 700 psi at top dead center. The pressure in the cylinder for the remaining 180 degrees is defined by Equation (8) (Reference [8]). Volume is a function of the piston position (Equation 3), bore and compression ratio. Air is assumed for the ideal gas and the corresponding constant is taken as 1.4.

$$Pressure ( θ ) = {P}_{1} \cdot {( \frac{Vol ( 0 )}{Vol ( θ )} )}^{γ - 1} \qquad ( 8 )$$

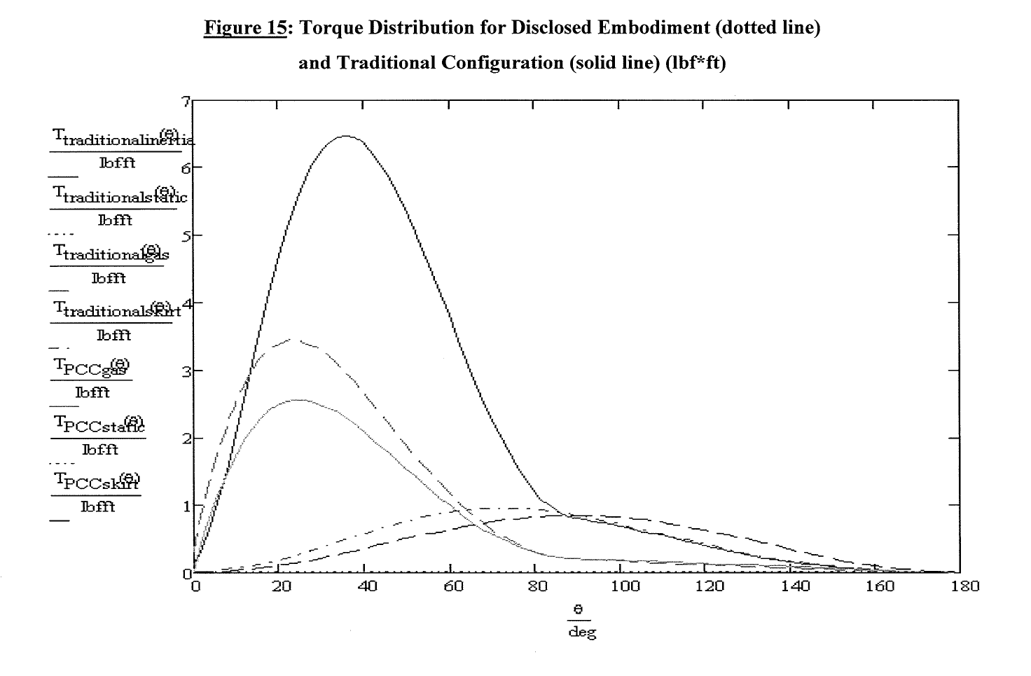

The pressure is then multiplied by the area of the piston face to give the applied vertical force from top dead center to bottom dead center. Using simple geometry and a free body diagram the resultant force applied along the connecting rod and, the horizontal force, between the piston and the cylinder wall may be calculated using Equations (9) and (10) respectively. To obtain the torque about the crankshaft axis the moment arm (Equation 11) is multiplied by the force exerted through the connecting rod. This yields the torque distribution seen in FIG. 15.

$$\begin{matrix}{F}_{2} ( θ ) = \frac{B \cdot ( P ( θ ) )}{cos ( asin ( \frac{c}{s} \cdot sin ( θ ) ) )} & ( 9 ) \\ {F}_{3} ( θ ) = \frac{B \cdot ( P ( θ ) )}{tan ( acos ( sin ( θ ) \cdot \frac{c}{s} ) )} & ( 10 ) \\ 1 ( θ ) = [ sin [ 180 deg - acos ( \frac{sin ( θ ) \cdot c}{s} ) - ( 90 deg - θ ) ] ] \cdot c & ( 11 ) \\ {T}_{traditional} ( θ ) = {F}_{2} ( θ ) \cdot 1 ( θ ) & ( 12 )\end{matrix}$$

A similar calculation may be used for the exemplary disclosed embodiment (PCC) where the moment arm is defined in Equation (14) and the force being exerted on the moment arm is defined in Equation (13).

F_{PCC}(ω):=B·(P(ω)) (13)

l_{PCC}(ω)=R₁·sin(ω) (14)

T_{PCC}(ω)=l_{PCC}(ω)·F_{PCC}(ω) (15)

Torque is calculated in the same way that it was in the traditional configuration, by multiplying the force by the moment arm (Equation 15). The resultant work may be calculated integrating the torque curve from 0 to 180 degrees (Equations 14-15). Total work of the traditional configuration comes to approximately 295 joules while the work of the exemplary disclosed embodiment comes to approximately 297 joules, producing a 0.01 percent discrepancy, acceptable for this calculation. These numbers ensure that the calculations were done properly as, if one were significantly larger than the other the system would not adhere to the law of conservation of energy. The resultant torque curves are plotted against each other in FIG. 15. The plots show a significantly more even curve where, the exemplary disclosed embodiment remains concave down throughout the power stroke. This shows that the exemplary disclosed embodiment would have a smoother output which is more significant to smaller engines with fewer pistons. Simulation of the fluid flow air-fuel mixture inside the combustion chamber during the intake stroke has not been taken into consideration. It is believed that there is less turbulence inside an engine using the exemplary disclosed embodiment and thus, poorer mixing tendencies.

$$\begin{matrix}{T}_{traditional} := \frac{1}{180 deg} \cdot {\int }_{0}^{180 deg} {T}_{traditional} ( θ ) d θ & ( 14 ) \\ {T}_{PCC} := \frac{1}{180 deg} \cdot {\int }_{0}^{180 deg} {T}_{PCC} ( θ ) d θ & ( 15 )\end{matrix}$$

### Friction and Efficiency

A model has been adapted from Zweiri, Whidborne and Seneviratne (References [6, 10, and 11]) to aid in calculating the instantaneous friction torque of the components comprised in both the PCC and the standard piston engine. This is a favorable model because of its flexibility in applying different constraints found in the PCC without developing new empirical coefficients.

Piston assembly friction torque is of particular importance because of the significant reduction in the side thrust exerted on the piston in the PCC. The piston rings dominate the total piston ring assembly friction (Reference [12]). Equations given in Reference [6] show three components to the ring assembly friction torque. They are comprised from static ring tension (Equation 16), gas pressure (Equation 17) and the inertia force (Equation 18).

$$\begin{matrix} {T}_{static} ( θ ) = η \cdot r \cdot \vert G ( θ ) \vert \cdot {\sum }_{i = 1}^{N} [ [ \frac{{E}_{i} \cdot gap}{7.07 \cdot {d}_{r} \cdot {( \frac{{d}_{r}}{{B}_{i}} - 1 )}^{3}} ] \cdot {B}_{i} \cdot {d}_{r} \cdot π ] & ( 16 ) \\ {T}_{gaspressure} ( θ ) = η \cdot r \cdot \vert G ( θ ) \vert \cdot {\sum }_{i = 1}^{N} ( {a}_{i} \cdot \vert P ( θ ) - {P}_{atm} \vert \cdot π \cdot {d}_{r} \cdot {B}_{i} ) & ( 17 ) \\ {T}_{inertia} ( θ ) = η \cdot r \cdot \vert G ( θ ) \vert \cdot [ \frac{\vert P ( θ ) - atm \vert \cdot ( \frac{π}{4} ) \cdot {b}^{2} - M \cdot {G}_{1} ( θ ) \cdot {( \dot{θ} )}^{2}}{η + {G}_{3} ( θ )} ] & ( 18 )\end{matrix}$$

The hydrodynamic friction coefficient is given in Equation (19) and changes according to cycle. Because it is a function of piston velocity, it is different in the disclosed embodiments than in the standard piston engine. The empirical coefficient, c₁ was used in calculating piston assembly friction torque. It was taken from the Stribeck diagrams assuming mixed lubrication. This number can be expected to be similar for both traditional and disclosed designs considering similarities in basic conception. In Equation (16) and (17) the subscript i refers to each piston ring while N is the number of piston rings. The reduction coefficient, a; is taken as 1 for the first ring and, 0.5 for the second.

$$η ( θ ) = {\sum }_{i = 1}^{N} [ {c}_{1} [ {c}_{1} - \sqrt{\frac{μ \cdot ω \cdot r \cdot \vert G ( θ ) \vert}{[ \frac{{E}_{i} \cdot gap}{7.07 \cdot {d}_{r} \cdot {( \frac{{d}_{r}}{{B}_{i}} - 1 )}^{3}} + \vert P ( θ ) - atm \vert ] \cdot {B}_{i}}} ] \cdot \vert sin ( θ ) \vert ] \\ for 1.5 π \leq θ \leq 2.5 π \\ η ( θ ) = \sqrt{\frac{μ \cdot ω \cdot r \cdot \vert G ( θ ) \vert}{[ \frac{{E}_{i} \cdot gap}{7.07 \cdot {d}_{r} \cdot {( \frac{{d}_{r}}{{B}_{i}} - 1 )}^{3}} + \vert P ( θ ) - atm \vert ] \cdot {B}_{i}}} \\ otherwise \qquad ( 19 )$$

The skirt friction torque is calculated using Equation (20) and is also a factor of piston velocity. The geometric function, Gₚ(θ) is the PCC sinusoidal equivalent for the velocity profile G(θ), used in the traditional engine.

$${T}_{traditionalskirt} ( θ ) = ( \frac{μ \cdot ω \cdot r \cdot G ( θ )}{{O}_{c}} ) \cdot b \cdot {L}_{s} \cdot r \cdot G ( θ ) \\ {T}_{PCCskirt} ( θ ) = ( \frac{μ \cdot ω \cdot r \cdot {G}_{p} ( θ )}{{O}_{c}} ) \cdot b \cdot {L}_{s} \cdot r \cdot {G}_{p} ( θ ) \qquad ( 20 )$$

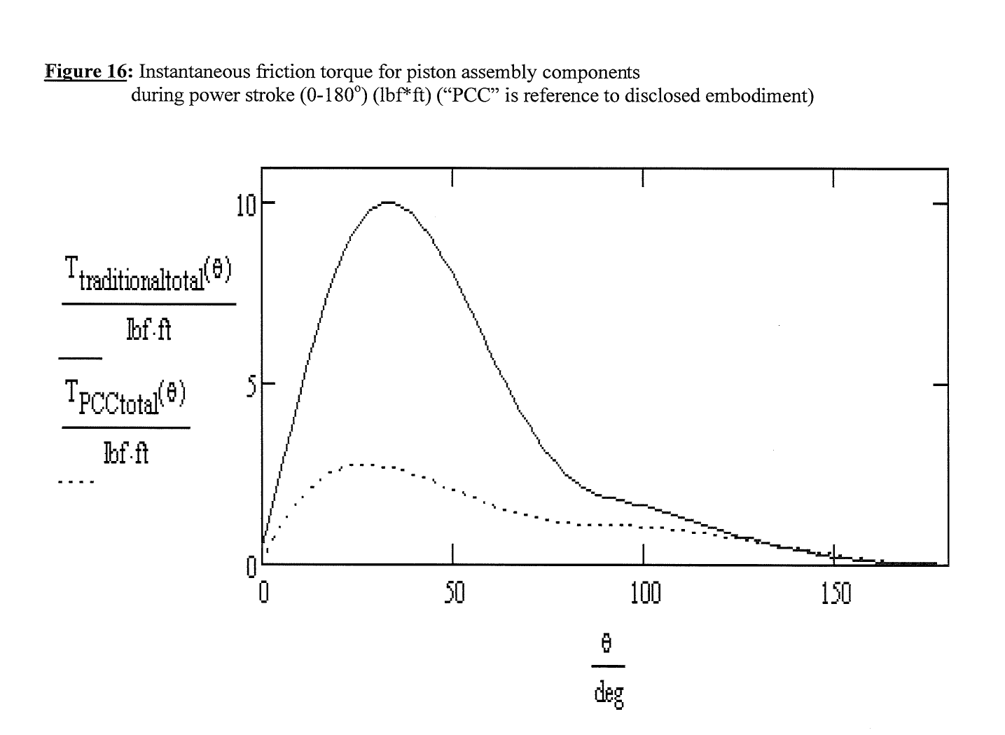

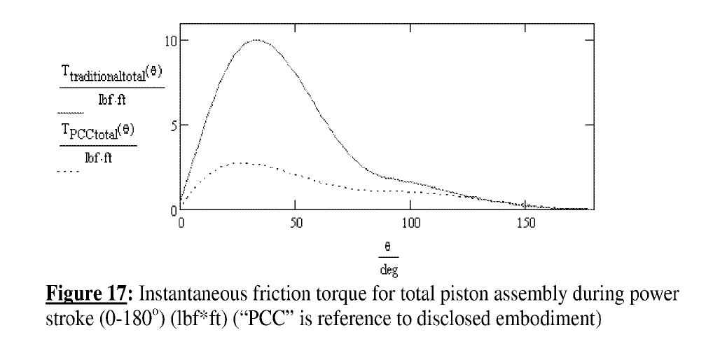

This model has been focused at measuring total piston assembly friction losses during the power stroke or, 0 to 180 degrees. This is the time when the highest mechanical losses occur due, to pressure exerted on the piston from the combustion process. To obtain the individual components of work for all parts of the piston assembly Equation (21) is used. A summary of results may be seen in Table (1) while graphical results may be seen in FIGS. 16 and 17.

W=∫_{θ}_{ᵢ}^{θ}^{_{f}}Tdθ (21)

TABLE 1
Summary of work done by piston assembly components (J)

| | | Disclosed |
|---|---|---|
| Torque | Traditional | Embodiment |
| Inertia | 8.295 | 0 |
| Static Ring Tension | 0.001361 | 0.0003214 |
| Gas Pressure Force | 4.058 | 3.164 |
| Skirt Friction | 1.858 | 1.805 |
| Total | 14.213 | 4.97 |

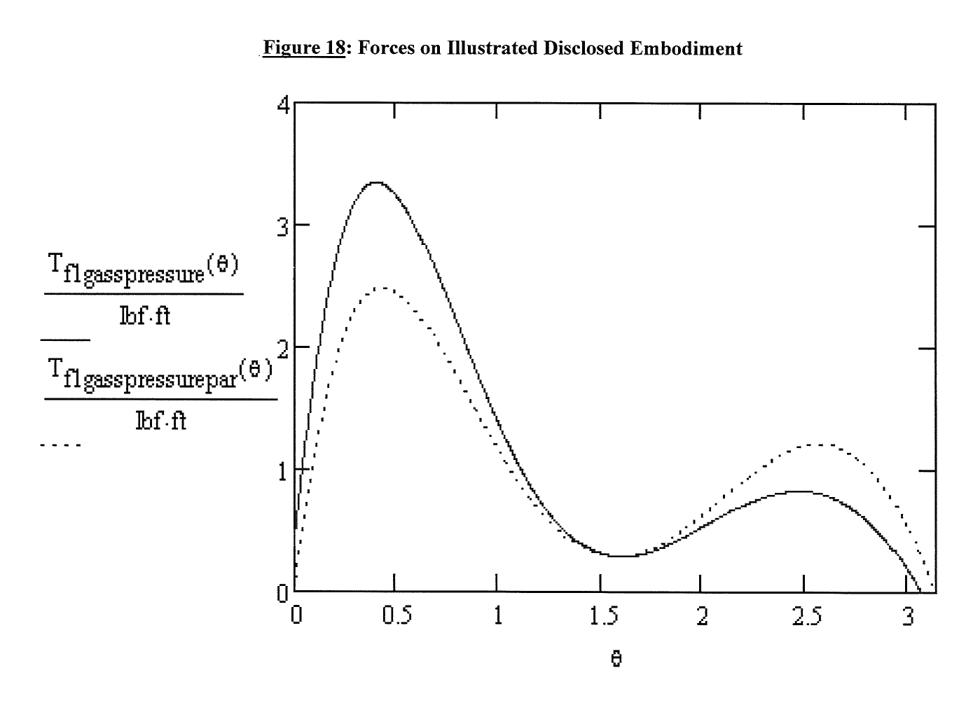

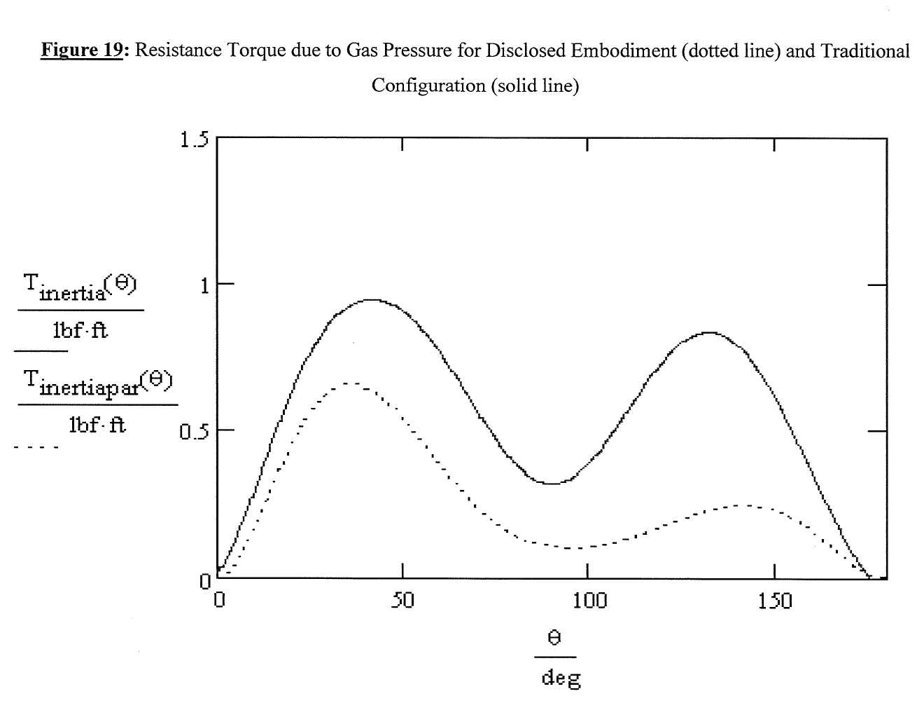

With respect to the presently illustrated disclosed embodiment, the horizontal inertia force may not be reduced to zero as forces transmitted to the gear and spacer require a horizontal force on the piston to balance the forces in the x-direction. A free body diagram of all forces and moments may be seen in FIG. 18. In this Figure the crank rotates about point A while the connection between the crank and piston is at point B. This configuration is complex to analyze as the force from the combustion chamber is exerted to the crank through the piston and also through the spacer. It is believed that this design is also operable without the gearing if the piston is constrained with respect to the crank at 90 degrees. At this angle without gearing the crank can rotate without causing any translational movement of the piston. The moment, lₘ transmitted to the crank through the spacer seen in FIG. 19 is given in Equation 22. The force exerted to the piston from the combustion chamber is Fᵢ. The resultant force exerted from the spacer to the crank is F_{cr} and the horizontal component of this force is Fₛₜ. The mass is M. This horizontal force may not be applied directly to the piston wall as the piston is constrained to the crank by the gearing at point B. A moment will be created about point B by these forces which are countered by the force, F₁ between the piston wall and the piston. To solve for these forces the sum of moments may be taken about point B (Equation 23). Solving for F₁ yields Equation 27. The side thrust force on the piston may then be found by taking the sum of moments about point B. This force may then be used in combination with the previous section to determine the friction losses in the piston assembly.

$$\begin{matrix}{l}_{m} ( θ ) = 2 \cdot c \cdot sin ( θ ) \cdot sin ( 90 - θ ) & ( 22 ) \\ \sum {M}_{B} = 0 = - {F}_{1} \cdot {l}_{2} + ( {F}_{i} + M \frac{d \dot{y}}{d t} ) \cdot {l}_{3} + {F}_{f} \cdot ( c + {l}_{3} ) & ( 23 ) \\ {F}_{f} = {F}_{1} \cdot η & ( 24 ) \\ {l}_{3} ( θ ) = c \cdot sin ( θ ) & ( 25 ) \\ {l}_{2} ( θ ) = {l}_{5} + \vert Stroke \cdot cos ( θ ) \vert & ( 26 ) \\ {F}_{1} = ( {F}_{i} + M \cdot \frac{d \dot{y}}{d t} ) \cdot \frac{{l}_{3}}{{l}_{2} + η \cdot c + η \cdot {l}_{2}} & ( 27 )\end{matrix}$$

The force coming through the spacer (e.g., 40) wants to push the piston against the piston wall. However, this force may not be transmitted as the piston is constrained in the x-direction by the contact of the shaft. This creates a resulting moment about point B. This moment is then countered by the force, F₁. If the piston was used in the horizontally opposed configuration there would be a resultant force on the opposite side of the opposed chamber. This would further spread the forces out reducing friction. FIGS. 19, 20 and 21 show the respective friction torque due to gas pressure, inertia and the total combined friction torque in the ring assembly. Taking the integral of the total torque over 180 degrees shows that the illustrative disclosed embodiment does approximately 30 percent less total work.

### Vibration

In modern engine development the improved control of internal imbalances in the motion of system components contributes to reduction of mechanical losses (Reference [14]). Fundamentally, better balanced engines raise less concern over material deformation, noise and vibration. This ultimately contributes to better overall performance. Traditional piston engines have inherent disadvantages in balancing due to the pistons irregular change in acceleration along their path of movement.

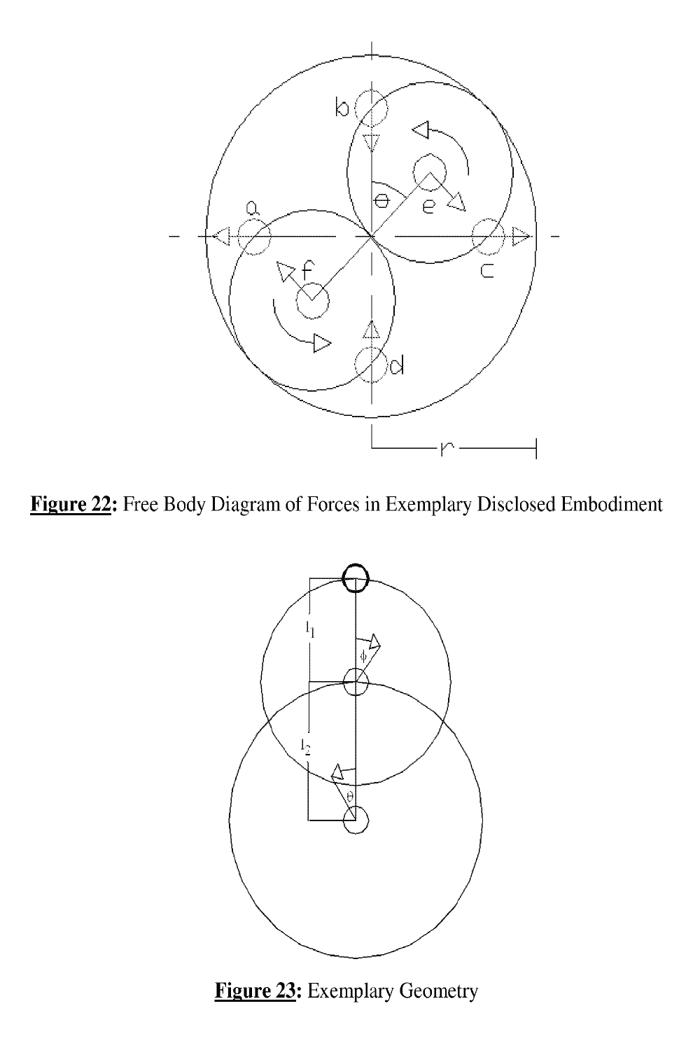

The disclosed exemplary system is much simpler system to analyze because all masses may be seen as rotating at a constant angular velocity about the crankshaft center or, moving in a linear sinusoidal motion through the center of the crankshaft (FIG. 22). This means that the acceleration profile is also sinusoidal and can thus be perfectly offset by the same profile 180 degrees ahead in the crankshaft rotation. The result is that the moment created about the crankshaft is constant and all forces in the x and y-directions are balanced. This balance may be achieved in any engine configuration. A total of at least four sinusoidal, reciprocating, linear moving masses, a-d would need to be used to obtain optimal balance in the horizontal and vertical directions. A four cylinder engine with all pistons opposed would need no counter weights. The rotating mass due to the pistons, counterweights and crankshaft would be largely

y″ₑ=mₑ·(½·r·ω²·cos(θ))y″_{f}=m_{f}·(½·rω²·cos(θ+180)) (28)

x″ₑ=mₑ·(½·r·ω²·sin(θ))x″_{f}=m_{f}·(½·rω²·sin(θ+180)) (29)

y″_{b}=m_{b}·(−r·ω²·cos(θ+180))

y″_{d}=m_{d}·(−r·ω²·cos(θ))

x″_{c}=m_{c}·(−r·ω²·cos(θ+90))

x″ₐ=mₐ·(−r·ω²·cos(θ−90)) (30)

x″ₑ+x″_{f}+x″_{c}+x″ₐ=0

y″ₑ+y″_{f}+y″_{b}+y″_{d}=0 (31)

Where the x-y origin is at the center of the larger circle, m represents mass and omega is the angular velocity of theta. The letters a-d represent pistons masses moving linearly while f and e represent the centers of mass for the offset crank and gearing components. All components are balanced.

In accordance with one embodiment, the housing can further define at least one intake valve and one exhaust valve proximate one end or at each end of the bore. If desired, the device can be an internal combustion engine wherein fuel is introduced into the intake valve during operation and combusted to drive the crankshaft. By way of further example, the device can be a pump or compressor, wherein a fluid to be pressurized by the device is introduced into the intake valve during operation. Preferably, the motion of the piston in the bore of the housing is sinusoidal.

### Exemplary Pedal and Crankshaft

The purpose of the illustrative exemplary design is to convert an elliptic or vertically reciprocating motion to angular rotation. Applications include, for example, those wherein a pedal and crankshaft are powered by a person. This is most commonly used in the bicycle. The advantage of this system is in the biomechanics of the human body and may differ from person to person. By changing the length of l₁ the rider may obtain a completely circular motion in the case that lᵢ is zero or a completely vertical motion in the case that l₁ is equal to l₂. The basic geometry of this mechanism may be seen in FIG. 23.

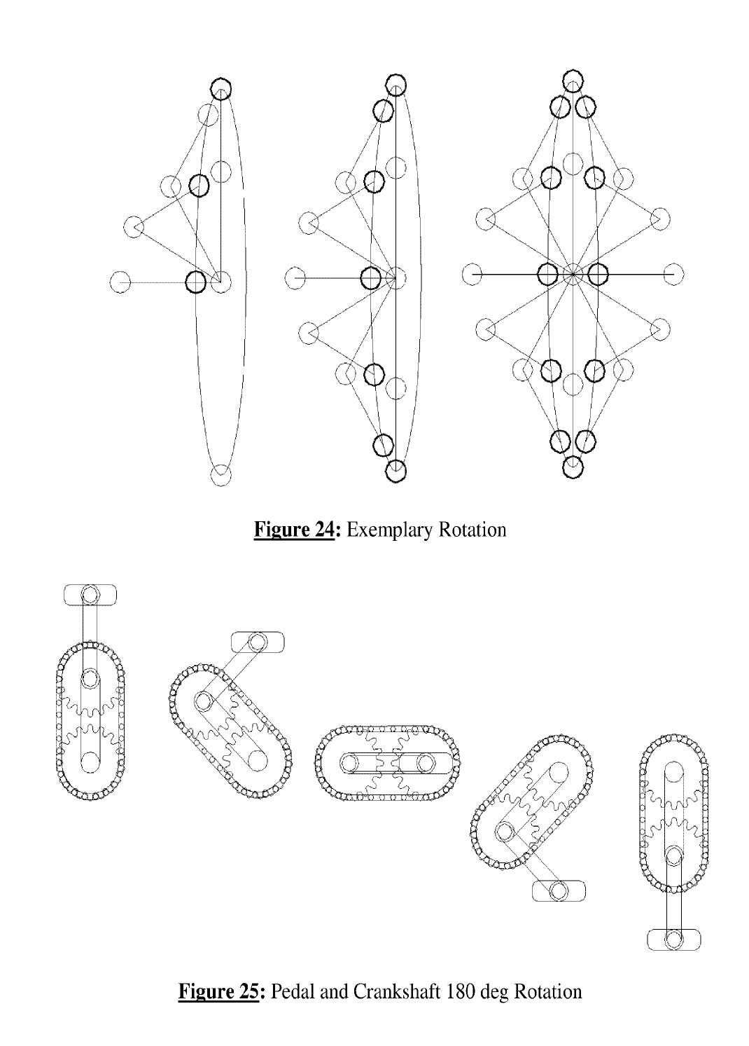

FIGS. 23 and 24 show l₁ as two thirds of l₂ creating the elliptical path seen in FIG. 24. FIG. 25 shows l₁ equal to l₂ giving the pedal a completely vertical reciprocating motion. To achieve this, the central sprocket is held stationary while the outer sprocket is rigidly attached to the outer crank (l₁). The rotation of the two sprockets is constrained by a chain seen in FIG. 25. This causes φ to rotate relative to θ at all times. The advantage to this system is that it allows the rider to determine the relative motion of the pedal. A longer down or push stroke may give an advantage to a circular motion allowing a faster smother pedal movement.

If desired, the subject device can instead include first and second gears (not shown) in lieu of sprockets and a chain as described above or a third idler gear (not shown) interposed between the first and second gears, wherein rotation of the first gear about the pivot point causes rotation of the second gear and the central shaft by way of the third gear. Preferably, the first sprocket and second sprockets (or gears, rollers or pulleys, described below) are of substantially the same diameter.

In accordance with a further alternative embodiment (not shown), the first crank portion can include a first roller affixed thereto in lieu of a sprocket in axial alignment with the pivot point, and wherein the central crankshaft includes a second roller affixed thereto in axial alignment with the axis of rotation. If desired, the device can further include a belt encircling the first and second rollers, wherein rotation of the first roller about the pivot point causes rotation of the second roller and the central shaft by way of the belt. Alternatively, the device can further include a third idler roller interposed between the first roller and second roller, wherein rotation of the first roller about the pivot point causes rotation of the second roller and the central shaft by way of the third roller.

In accordance with yet another embodiment (not shown), the first crank portion can include a first pulley in lieu of a sprocket affixed thereto in axial alignment with the pivot point, and wherein the central crankshaft includes a second pulley affixed thereto in axial alignment with the axis of rotation. The device can further include a belt encircling the first and second pulleys, wherein rotation of the first pulley about the pivot point causes rotation of the second pulley and the central shaft by way of the belt. If desired, the belt and pulleys can have interdigitating teeth.

In accordance with still a further embodiment (not shown), a machine is provided including a sprocket/gear/roller/pulley drive mechanism as described hereinabove. The machine can be, for example, a bicycle, a tricycle, a quadricycle, an exercise bicycle, an electric generator, a pedal taxi or a paddleboat.

The methods and systems of the disclosed embodiments, as described above and shown in the drawings, provide for drive systems with superior attributes as compared with conventional devices in the art. It will be apparent to those skilled in the art that various modifications and variations can be made in the device and method of the disclosed embodiments without departing from the spirit or scope of the disclosure. Thus, it is intended that the disclosed embodiments include modifications and variations that are within the scope of the appended claims and their equivalents. Each references mentioned herein (and below) is incorporated by reference herein in its entirety.

### REFERENCES

1 Rao, S. S. Mechanical Vibration, 1990 (Addison-Wesley, Reading, Mass.).
2 Uras, M. H. and Patterson, D. J. Measurement of piston and ring assembly friction instantaneous IMEP method. SAE technical paper 830416, 1983
3 Mcgeehan, J. A. A literature review of the effect of piston and ring friction and lubricating oil viscosity on fuel economy. SAE paper 780673, 1978
4 Ku, Y. and Patterson, D. J. Piston and ring friction by the fixed sleeve method. SAE paper 880571, 1988.
5 Taraza, D., Henein, N., and Bryzink, W. Friction losses in multi-cylinder diesel engines. SAE paper 2000-01-0921, 2000
6 Zweiri, Y. H., Whidborne, J. F. and Seneviratne, L. D. Instantaneous friction components model for transient engine operation. Proc. Instn Mech. Engrs, Vol 214, Part D, 2000, 809-824
7 Seggern, D. H. Practical Handbook of Curve Design and Generation, 1994 (CRC Press, Inc.)
8 Pukjrabek, W. W. Engineering Fundamentals of the Internal Combustion Engine, Second Edition, 1997 (Pearson Prentice-Hall)
9 Boles, M. A. and Cengel, Y. A. Thermodynamics an Engineering Approach Fourth Edition, 2002 (McGraw-Hill)
10 Zweiri, Y. H., Whidborne, J. F. and Seneviratne, L. D. Detailed analytical model of a single-cylinder diesel engine in the crank angle domain Proc. Instn Mech. Engrs, Vol 215, Part D, 2001
11 Zweiri, Y. H., Whidborne, J. F. and Seneviratne, L. D. Dynamic simulation of a single-cylinder diesel engine including dynamometer modeling and friction. Proc. Instn Mech. Enfre, Part D, Journal of Automobile Engineering, 1999, 213(D4), 391-402
12 Furuhama, S., Takiguchi, M. and Tomizawa, K. Effect of piston and piston rig designs on the piston friction forces in diesel engines. SAE paper 810977, 1981
13 Terauchi, Y., Nagamura, K. and Ikejo, K. Study on Friction Loss of Internal Gear Drives (Influence of Pinion Surface Finishing, Gear Speed and Torque). JSME International Journal Series III, Vol. 34, No. 1, 1991
14 Perera, M. S. M., Theodossiades, S. and Rahnejat, H. A multi-physics multi-scale approach in engine design analysis. Proc. IMechE Vol. 221 Part K: J. Multi-body Dynamics
15 Taylor, C. F. The Internal Combustion Engine in Theory and Practice Volume 2: Combustion, Fuels, Materials, Design Revised Edition, 1985 (The M.I.T. Press)

What is claimed is:

1. A device for converting linear motion into rotational motion, comprising;
a) a housing defining at least one bore therein along a first direction;
b) a piston movably disposed in the bore of the housing, the piston defining a generally circular bore therethrough along a direction generally perpendicular to the first direction, the bore of the piston defining a first engagement surface having a first diameter;
c) a crankshaft defining an axis of rotation and generally elongate body, the body having an offset portion that is laterally displaced from the axis of rotation, the surface of the offset portion defining a second engagement surface thereon having a generally circular cross-section and a second diameter, wherein:
(i) the second diameter is about one half of the first diameter;
(ii) the second engagement surface is adapted to engage with the first engagement surface;
(iii) the crankshaft is forced through an angular rotation when the piston is displaced along the bore; and
(iv) the axis of rotation of the crankshaft does not move with respect to the housing.

2. The device of claim 1, further comprising a bearing interposed between (i) a generally circular track defined in the bore of the piston and (i) the surface of the crankshaft, wherein the bearing maintains the engagement between the first and second engagement surfaces when the piston is displaced along the bore of the housing resulting in rotation of the crankshaft.

3. The device of claim 2, wherein the bearing is generally crescent-shaped.

4. The device of claim 1, wherein the first and second engagement surfaces define interdigitating gear teeth thereon.

5. The device of claim 1, wherein the piston bore and cross section of the offset portion of the crankshaft defining the second engagement surface are circular in shape.

6. The device of claim 1, wherein the housing further defines a second bore therein, and the device further includes a second piston movably disposed in the second bore of the housing, the second piston defining a generally circular bore therethrough along a direction generally perpendicular to the first direction, the bore of the piston defining a third engagement surface having a first diameter that is adapted and configure to mate with a fourth engagement surface defined on a second offset portion of the crankshaft.

7. The device of claim 1, wherein the piston is adapted and configured to reciprocate along the bore of the housing when the crankshaft rotates.

8. The device of claim 7, wherein the housing further defines at least one intake valve and one exhaust valve proximate each end of the bore.

9. The device of claim 8, wherein the device is an internal combustion engine, and fuel is introduced into the intake valve during operation and combusted to drive the crankshaft.

10. The device of claim 8, wherein the device is a pump or compressor, and a fluid to be pressurized by the device is introduced into the intake valve during operation.

11. The device of claim 1, wherein the motion of the piston in the bore of the housing is sinusoidal.

12. A device for converting elliptic or linear reciprocating motion into angular motion, comprising;
a) a central shaft defining an axis of rotation;
b) a first crank portion; and
c) a second crank portion lying in substantially the same plane as the first crank portion and pivotally attached to the first crank portion at a pivot point, wherein:
i) the second crank portion is adapted to freely pivot about the central shaft about the axis of rotation;
ii) the pivot point is separated by a distance l₂ from the axis of rotation;
iii) the first crank portion includes a load receiving point displaced a distance l₁ from the first pivot point; and
iv) the second crank portion extends substantially perpendicularly from the central shaft.

13. The device of claim 12, wherein the first crank portion includes a first sprocket affixed thereto in axial alignment with the pivot point, and wherein the central crankshaft includes a second sprocket affixed thereto in axial alignment with the axis of rotation.

14. The device of claim 13, further comprising a chain loop encircling the first and second sprockets, wherein rotation of the first sprocket about the pivot point causes rotation of the second sprocket and the central shaft by way of the chain.

15. The device of claim 13, further comprising a third idler sprocket interposed between the first sprocket and second sprocket, wherein rotation of the first sprocket about the pivot point causes rotation of the second sprocket and the central shaft by way of the third sprocket.

16. The device of claim 12, wherein lᵢ is substantially equal to l₂, resulting in the load receiving point traversing a substantially linear path as the central shaft is angularly driven.

17. The device of claim 12, wherein l₁ is less than l₂, resulting in the load receiving point traversing a substantially elliptical path as the central shaft is angularly driven.

18. The device of claim 13, wherein the first sprocket and second sprocket are of substantially the same diameter.

19. The device of claim 12, wherein the first crank portion includes a first roller affixed thereto in axial alignment with the pivot point, and wherein the central crankshaft includes a second roller affixed thereto in axial alignment with the axis of rotation.

20. The device of claim 19, further comprising a belt encircling the first and second rollers, wherein rotation of the first roller about the pivot point causes rotation of the second roller and the central shaft by way of the belt.
